(19) United States
(12) Patent Application Publication
(10) Pub. No.: US 2024/0208542 A1
(43) Pub. Date: Jun. 27, 2024

(54) ADAPTIVE BATCHING FOR OPTIMIZING EXECUTION OF MACHINE LEARNING TASKS

(71) Applicant: Toyota Motor Engineering & Manufacturing North America, Inc., Plano, TX (US)

(72) Inventors: Chianing Wang, Mountain View, CA (US); Ariana Joy Mann, Stanford, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/087,425

(22) Filed: Dec. 22, 2022

(51) Int. Cl. B60W 60/00; G06F 9/48

(52) U.S. Cl. CPC B60W 60/0023; G06F 9/4881

(57) ABSTRACT

Systems, methods, and other embodiments described herein relate to improving the processing of machine learning (ML) tasks by selectively adapting batch sizes and execution timing to optimize latency and energy consumption. In one embodiment, a method includes receiving, in a queue, tasks for execution, the tasks being requests to execute a machine-learning model. The method includes evaluating a current state of the queue according to a batching model to determine when to execute a batch of the tasks by generating a cost of executing the batch at a current time. The method includes, responsive to determining that the cost satisfies a batch threshold, controlling a batching processor to execute the batch using the machine-learning model.

### TECHNICAL FIELD

The subject matter described herein relates, in general, to improving the execution of machine learning tasks in batches and, more particularly, to selectively adapting batch sizes and execution timing to optimize latency and energy consumption.

### BACKGROUND

Recent progress in machine learning (ML) performance means that more and more ML algorithms are being used in real-world systems. In general, ML models are evaluated on new data samples to produce prediction outputs, which may be supplied to systems in real-time. This process is generally referred to as ML inference. ML inference is a latency-sensitive task since it is a limiting factor for how long an ML-powered task takes, such as decisions about autonomous driving (e.g., decisions about whether it is safe to turn at an intersection), and so on. At the same time, Graphical Processing Units (GPUs) and other processing hardware accelerate the types of computation (generally matrix multiplication) used for large-scale machine learning models like deep neural networks (DNNs). In particular, matrix multiplication enables vectorized computation for parallelism of the same computation for multiple inputs. However, computation in this way generally relies on batch-based computations where the inputs are available for evaluating multiple tasks at the same time. Accordingly, satisfying latency demands for individual tasks in a batch-based approach can be cumbersome, especially in view of further qualifications, such as optimization of energy consumption for the processing hardware. Consequently, the efficient execution of batch-based tasks encounters various difficulties when attempting to optimize latency versus energy consumption.

### SUMMARY

In various embodiments, example systems and methods relate to a manner of improving the processing of machine learning (ML) tasks by selectively adapting batch sizes and execution timing to optimize latency and energy consumption. As previously noted, satisfying latency requirements for tasks that are batched together while also considering energy-efficiency is a complex task. Therefore, in various embodiments, an inventive system is disclosed that improves the processing of ML tasks. For example, in at least one approach, the system monitors a current state of a queue as tasks are received. In general, the tasks are requests to execute a machine-learning model over a set of data in order to provide at least one inference as an output per data input. The task may be related to various applications, such as computer vision, planning recommendations, etc., in relation to an autonomous vehicle or other ML-based applications. Accordingly, remote data-capturing devices generally communicate the tasks to the system to offload the processing and receive a result in response. Depending on the type of application, the tasks may be time sensitive and thus vulnerable to extended latencies.

In any case, the system evaluates the current state of the queue according to a batching model. The batching model is, in at least one approach, a probabilistic model that is based on a Markov chain model and that evaluates costs associated with executing a batch of a given size or delaying execution until a later time when more tasks are waiting to be processed. Accordingly, depending on the state of the queue, the system dynamically selects the batch size and may execute the batch. In general, the batching model determines costs according to a tradeoff between latency and energy consumption as may be defined according to a regularization parameter that is set during, for example, pre-configuration of the system. Thus, when the cost satisfies a batching threshold, the system sets the batch size and executes the batch using the machine-learning model. Once complete, the system then communicates the results back to respective remote devices. Accordingly, through the evaluation of the queue and selective adjustment of batch sizes, the system improves both latency and energy consumption.

In one embodiment, a batching system for improving the execution of machine-learning tasks is disclosed. The parking system includes one or more processors and a memory communicably coupled to the one or more processors. The memory stores a control module including instructions that, when executed by the one or more processors, cause the one or more processors to receive, in a queue, tasks for execution, the tasks being requests to execute a machine-learning model. The control module includes instructions to evaluate a current state of the queue according to a batching model to determine when to execute a batch of the tasks by generating a cost of executing the batch at a current time. The control module includes instructions to, responsive to determining that the cost satisfies a batch threshold, control a batching processor to execute the batch using the machine-learning model

In one embodiment, a non-transitory computer-readable medium for improving execution of machine-learning tasks and including instructions that, when executed by one or more processors, cause the one or more processors to perform one or more functions is disclosed. The instructions include instructions to receive, in a queue, tasks for execution, the tasks being requests to execute a machine-learning model. The instructions include instructions to evaluate a current state of the queue according to a batching model to determine when to execute a batch of the tasks by generating a cost of executing the batch at a current time. The instructions include instructions to responsive to determining that the cost satisfies a batch threshold, control a batching processor to execute the batch using the machine-learning model.

In one embodiment, a method is disclosed. In one embodiment, the method includes, receiving, in a queue, tasks for execution, the tasks being requests to execute a machine-learning model. The method includes evaluating a current state of the queue according to a batching model to determine when to execute a batch of the tasks by generating a cost of executing the batch at a current time. The method includes, responsive to determining that the cost satisfies a batch threshold, controlling a batching processor to execute the batch using the machine-learning model.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one clement may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a batching system associated with improving the latency and energy consumption when executing batches of tasks.

FIG. 3 illustrates a diagram of a batching system within a cloud-computing environment.

FIG. 4 is a flowchart illustrating one embodiment of a method associated with adapting batch sizes for tasks.

FIG. 5 is a diagram illustrating one example of a batching model.

FIG. 6 illustrates an example processing environment in which an autonomous vehicle provides tasks.

### DETAILED DESCRIPTION

Systems, methods, and other embodiments associated with a manner of improving the processing of machine learning (ML) tasks by selectively adapting batch sizes to optimize latency and energy consumption are disclosed. In one or more embodiments, a batching system is disclosed that improves the processing of ML tasks. For example, in at least one approach, the batching system receives and queues tasks that are requests for execution of a machine-learning model over specific data in the requests. In general, the machine-learning model provides an inference about the data and communicates a result back to an original requestor, which may be a remote device executing an application, such as an autonomous driving application on a vehicle. As one example, the task may be related to computer vision, planning recommendations, etc. in relation to the operation of an autonomous vehicle. Accordingly, remote devices (e.g., vehicles) generally communicate the tasks to the batching system to offload the processing and receive a result in response. Depending on the type of application, the tasks may be time sensitive and thus vulnerable to extended latencies. That is, for example, the perception of an environment (e.g., obstacles) is dynamic such that delayed results can be stale and, thus, not useful to the application when the delay exceeds a defined time. Of course, in a similar vein, separately executing each individual task can be inefficient in relation to the use of energy. Accordingly, the batching system can adapt the batching model to tradeoff between energy consumption and latency of processed tasks by selectively adapting a batch size according to predefined parameters and the current state of the queue.

In one aspect, the batching system evaluates the current state of the queue according to the batching model. The batching model is, in at least one approach, a probabilistic model that is based on a Markov chain model and that evaluates costs associated with executing a batch of a given size (i.e., current contents of the queue) or delaying execution until a later time with additional tasks. Accordingly, depending on the state of the queue, the system dynamically selects the batch size and may execute the batch. In general, the batching model determines costs according to a tradeoff between latency and energy consumption as may be defined according to a regularization parameter that is set during, for example, pre-configuration of the system. Thus, when the cost satisfies a batching threshold, the system sets the batch size and executes the batch using the machine-learning model. Once complete, the system then communicates the results back to respective remote devices. Accordingly, through the evaluation of the queue and selective adjustment of batch sizes, the system improves both latency and energy consumption. In this way, the batching system improves the execution of tasks in regards to energy consumption while still considering latency.

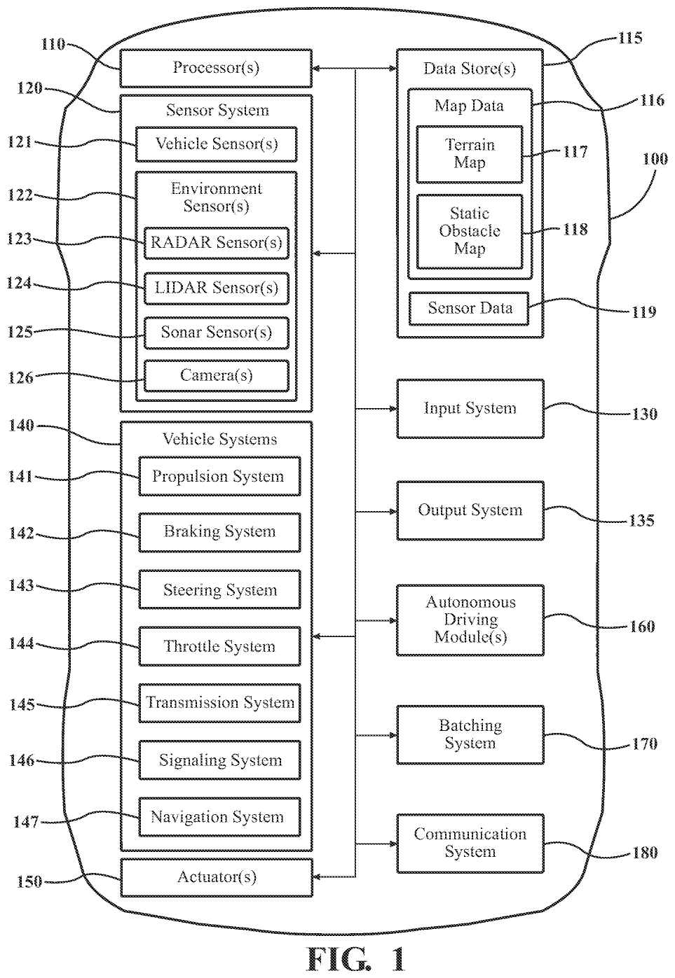

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any device that, for example, executes applications that offload ML-based tasks. In various approaches, the vehicle 100 may be an automated vehicle. As used herein, an automated vehicle refers to a vehicle with at least some automated driving functions. Thus, the vehicle 100 may operate autonomously, semi-autonomously, or with the assistance of various advanced driving assistance systems (ADAS). Further, the vehicle 100 is generally a connected vehicle that is capable of communicating wirelessly with other devices, such as other connected vehicles, infrastructure elements (e.g., roadside units), cloud-computing elements, and so on. Moreover, while the present disclosure is generally described in relation to the vehicle 100, in yet further approaches, the noted systems and methods disclosed herein may be implemented as part of other entities, such as electronic devices, servers, and so on, that are not associated with a particular form of transport.

In any case, the vehicle 100 also includes various elements. It will be understood that, in various embodiments, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system 170 can be implemented within the vehicle 100, while further components of the system 170 are implemented within a cloud-based environment, as discussed further subsequently.

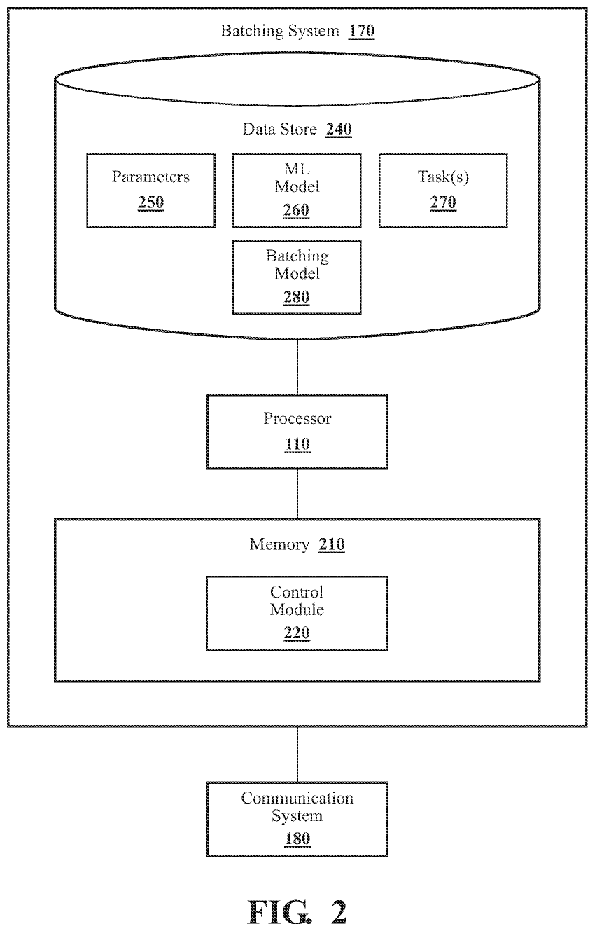

Some of the possible elements of the vehicle 100 are shown in FIG. 1 and will be described along with subsequent figures. However, a description of many of the elements in FIG. 1 will be provided after the discussion of FIGS. 2-6 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 100 includes a batching system 170 that is implemented to perform methods and other functions as disclosed herein relating to determining when to execute or delay a batch in order to accommodate considerations of latency and energy consumption.

Moreover, the batching system 170, as provided for within the context of autonomous vehicles, functions in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a WiFi, DSRC, V2I, V2V, or another suitable protocol for communicating between the vehicle 100 and other entities in the cloud environment. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the batching system 170 can leverage various wireless communication technologies to provide communications to other entities, such as members of the cloud-computing environment, when communicating a task for execution by a cloud-based element.

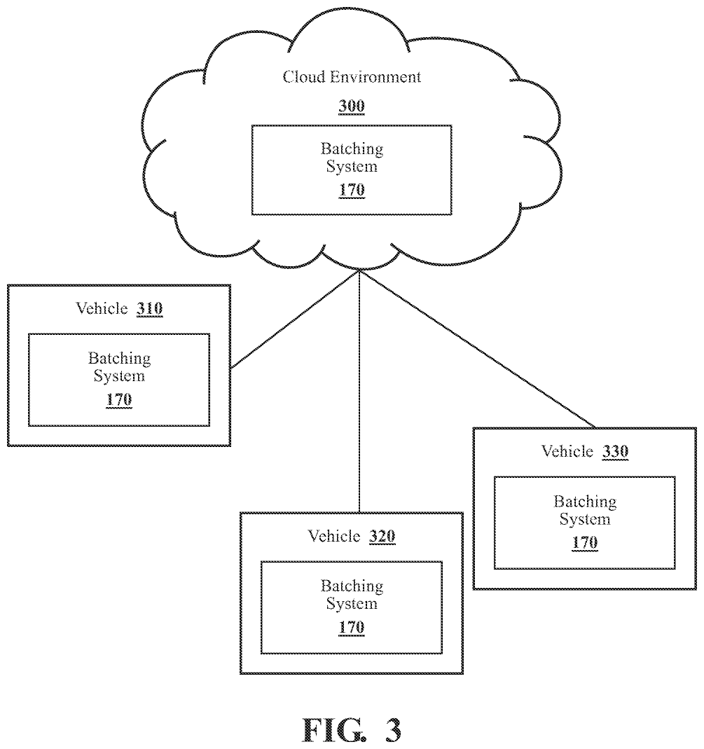

With reference to FIG. 2, one embodiment of the batching system 170 is further illustrated. The batching system 170 is shown as including a processor 110 from the vehicle 100 of FIG. 1. Accordingly, the processor 110 may be a part of the batching system 170, the batching system 170 may include a separate processor from the processor 110 of the vehicle 100, or the batching system 170 may access the processor 110 through a data bus or another communication path. In further aspects, the processor 110 is a cloud-based resource. Thus, the processor 110 may communicate with the batching system 170 through a communication network or may be co-located with the batching system 170. It should be appreciated that while specific configurations of the processor 110 are discussed, the batching system 170 may implement the processor 110 in various forms depending on an implementation of a particular instance of the batching system 170 as described further in relation to FIG. 3.

Continuing with FIG. 2, in one embodiment, the batching system 170 includes a memory 210 that stores a control module 220. The memory 210 is a random-access memory (RAM), read-only memory (ROM), a hard-disk drive, a flash memory, or other suitable memory (either volatile or non-volatile) for storing the module 220 and/or other information used by the batching system 170. The module 220 is, for example, computer-readable instructions within the physical memory 210 that, when executed by the processor 110, cause the processor 110 to perform the various functions disclosed herein.

As previously noted, the batching system 170 may be further implemented as part of a cloud-based system that functions within a cloud environment 300, as illustrated in relation to FIG. 3. As shown in FIG. 3, the cloud environment comprises client instances that are included within separate vehicles 310, 320, and 330 along with a cloud-based server instance. The separate client instances of the batching system 170 may acquire data (e.g., telematics data, sensor data, etc.) within the vehicles that is to be processed into various determinations/inferences. As previously noted, the determinations/inferences can be in relation to path planning, perception, and other tasks associated with the vehicles 310-330, or, more generally, any application that is executing on the vehicles 310-330. The instances in the vehicles function to offload the acquired data as a request in the form of a task to the cloud-based instance. In one or more approaches, the cloud environment 300 may facilitate communications between multiple different vehicles and the cloud environment 300 to communicate information, including tasks and results of tasks.

Accordingly, as shown, the batching system 170 may include separate instances within one or more entities of the cloud-based environment 300, such as servers, and also instances within vehicles that function cooperatively to acquire, analyze, and distribute the noted information. In a further aspect, the entities that implement the batching system 170 within the cloud-based environment 300 may vary beyond transportation-related devices and encompass mobile devices (e.g., smartphones), and other such devices that benefit from the functionality of offloading ML-based tasks. Thus, the set of entities that function in coordination with the cloud environment 300 may be varied. Additionally, the cloud-based environment 300 itself is a dynamic environment that comprises cloud members, which may vary over time. As such, the illustration of FIG. 3 is provided as an example only and should not be construed as limited the batching system to the number or configuration of devices as shown.

Continuing with FIG. 2 and a general embodiment of the batching system 170, in one or more arrangements, the batching system 170 includes a data store 240. The data store 240 is, in one embodiment, an electronic data structure (e.g., a database) stored in the memory 210 or another electronic memory and that is configured with routines that can be executed by the processor 110 for analyzing stored data, providing stored data, organizing stored data, and so on. Thus, in one embodiment, the data store 240 stores data used by the module 220 in executing various functions. In one embodiment, the data store 240 includes the parameters 250, a machine-learning model 260, tasks 270, a batching model 280, and/or other information that is used by the module 220. It should be appreciated that while the data store 240 is shown as including the parameters 250, the ML model 260, the tasks 270, and the batching model 280, separate instances of the batching system 170 may implement the data store 240 to include different sets of information.

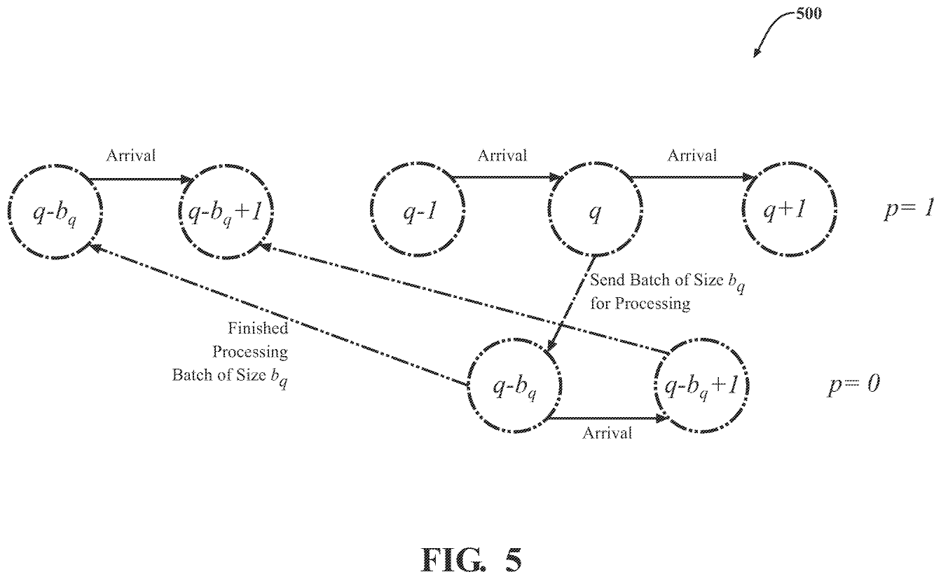

In any case, the control module 220 includes instructions that function to control the processor 110 to acquire the parameters 250 and implement the parameters 250 as part of the batching model 280. In general, the parameters 250 define how the batching model 280 determines a tradeoff between latency and energy consumption. In at least one approach, the parameters 250 include a regularization parameter that defines the tradeoff. In further approaches, the parameters 250 include a carbon footprint cost parameter that specifies whether the batching model 280 should consider a source of energy used to process tasks (i.e., green energy versus standard). The batching model 280 itself will be discussed with greater specificity in relation to FIG. 5.

In any case, the batching model 280 is a probabilistic model that is based on a Markov decision Process (MDP) that models a single first-in-first-out (FIFO) queue and a single processor (e.g., a single graphics processing unit (GPU)). It should be noted that while the batching system 170 illustrates a single processor 110, the batching system 170 may control the batching model to execute on a separate processor that is, for example, a GPU that is distinct from the processor 110. In any case, the ML model 260, as described in various embodiments herein, is intended to execute on a single processor and is not generally executed across multiple separate processors itself. In yet further aspects, the control module 220 may also execute on the same single processor as the ML model 260 along with other functions described herein. In general, the batching model 280 considers a current state of the queue at each timestep in regards to costs of energy consumption for processing the tasks 270 that are currently in the queue and costs associated with a latency of the tasks 270. In one arrangement, the energy is the total energy consumed by a processor that executes the ML model 260 in a given timestep, the latency is the time from when a task enters the queue until it is finished processing. Thus, the batching model 280 can implement the parameters 250 (e.g., the regularization parameter) to adjust the contribution of the costs of energy and latency to an overall cost when assessing the current state of the queue.

Continuing with elements of the data store 240, in one or more arrangements, the ML model 260 is a deep neural network (DNN), such as a convolutional neural network (CNN), a recurrent neural network (RNN), a transformer network, an autoencoder, a generative neural network, and so on. The ML model 260 may be at least partially integrated as part of the control module 220 and may execute on the processor 110 or another processor associated with the batching system 170. For example, the ML model 260 executes on a devoted specialized processor, such as a GPU. The ML model 260 is naturally parallelized on the processor in order to execute multiple tasks as a batch. The tasks, as previously explained, are requests to the processor to execute the ML model 260 over a request-specific set of data. Depending on the particular model the exact form of the task may vary but includes at least the set of data along with identifying information of the requestor.

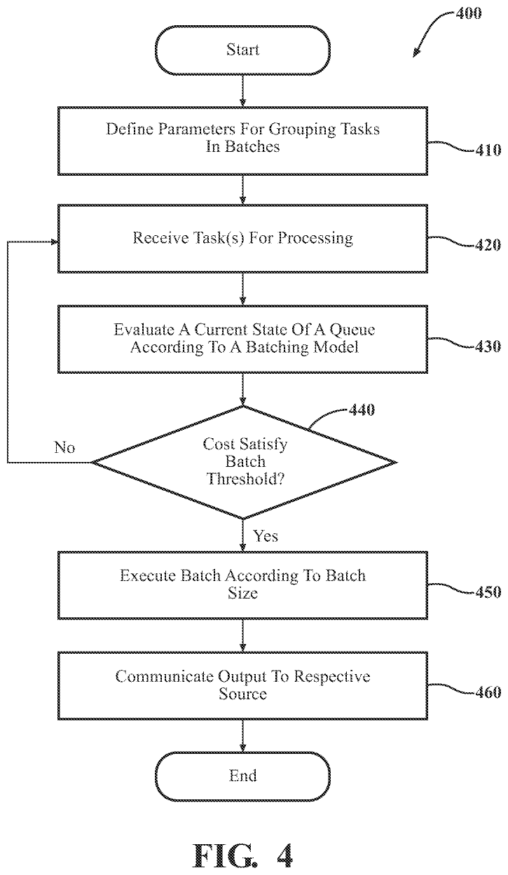

Additional aspects about adapting batch sizes when executing ML-based tasks will be described in relation to FIG. 4. FIG. 4 illustrates a flowchart of a method 400 that is associated with adaptive batching for ML-based tasks. Method 400 will be discussed from the perspective of the batching system 170 of FIGS. 1-2 as implemented within the cloud-based environment 300. While method 400 is discussed in combination with the batching system 170, it should be appreciated that the method 400 is not limited to being implemented within the batching system 170 but is instead one example of a system that may implement the method 400. Furthermore, while the method is illustrated as a generally serial process, various aspects of the method 400 can execute in parallel to perform the noted functions.

At 410, the control module 220 defines the parameters 250 for grouping tasks into batches. In one or more arrangements, the control module 220 defines the parameters 250 as a preconfiguration step. That is, the control module 220 may prepare the batching model 280 by setting one or more aspects of the batching model 280, such as variables (e.g., weights). In at least one configuration, the control module 220 acquires the parameters 250 via an interface (e.g., a human-machine interface (HMI)) prior to executing any of the tasks 270. The parameters 250 permit the batching system 170 to select an extent of a tradeoff between latency and energy efficiency. For example, providing a pure preference to latency would generally result in a batch size that is much smaller, such as a single task per batch, whereas a setting the parameters 250 to prefer energy consumption would generally result in a larger batch size that, for example, is equivalent to a total number of tasks that the queue can store. Thus, the control module 220 defines the parameters 250 according to inputs in order to balance the tradeoff.

At 420, the control module 220 receives the tasks 270 and stores the tasks 270 in a queue. It should be appreciated that while the control module 220 is described as receiving the tasks at 270, for various timesteps, the control module 220 may or may not actually receive tasks, and may further receive a single task or multiple tasks at a time. In any case, the control module 220 receives and stores the tasks in the queue according to a first-in-first-out arrangement. Thus, timing of arrival between the tasks 270 dictates an order within the queue. As an additional aspect, the size of the queue, in one or more arrangements, corresponds to a size of the memory of the processor (e.g., GPU). Of course, in further aspects, the batching system 170 defines the queue to span multiple memory devices. Thus, the queue may have an upper boundary for a number of the tasks 270 that the control module 220 can store. The batching model 280 generally considers a current state of the queue as a primary input when evaluating whether to proceed with executing a batch or delaying execution until a subsequent time. Thus, the control module 220 generally monitors queue for how many tasks are currently queued. The control module 220, in at least one configuration, further determine an arrival rate of the tasks into the queue, and whether a batch is currently executing or not.

At 430, the control module 220 evaluates the current state of the queue according to the batching model 280. In one or more approaches, the control module 220 uses the batching model 280 to determine when to execute a batch of the tasks 270 by generating a cost of executing the batch, which may occur at each time step. The batching model 280 defines the energy and latency costs associated with executing a batch having a batch size that is, for example, equivalent to a number of tasks that are presently in the queue. Thus, the control module 220 evaluates the current state in order to dynamically adapt the batch size to a current size of the queue as defined by whether a cost generated by the batching model 280 satisfies a batch threshold. The general effect of the evaluation is a determination about whether to delay execution of the batch or proceed with execution that is provided in the form of cost.

At 440, the control module 220 determines whether the cost generated by the batching model 280 satisfies a batch threshold. In one configuration, the batch threshold defines a limit for the cost that optimally balances the latency with energy consumption according to the parameters 250. Thus, depending on a particular configuration of the batch threshold and the cost, the control module 220 may determine that the cost satisfies the batch threshold according to the cost being less than the batch threshold, being greater than the batch threshold, equaling the batch threshold, or otherwise simply exceeding the threshold from a nominal state. When the cost satisfies the batch threshold, the control module 220 proceed to execute the batch at block 450. Otherwise, the monitoring and evaluation of the queue continues until the batch threshold is satisfied.

The batch threshold is, in one or more configurations, set via the solution to a dynamic program, implemented by the batching system 170, based on the Markov decision process of the batching model. The dynamic program considers the batch processing time and batch energy consumption for different batch sizes, as well as a selected regularization parameter value. The solution to the dynamic program is a cost threshold for each possible batch size that is specific to the processing time cost of the processor and potential batch size, the energy cost of the processor and potential batch size, and the regularization parameter set between the two costs.

At 450, the control module 220 controls the execution of the batch using the ML model 260. It should be appreciated that the execution of the tasks 270 involves natural parallel execution (i.e., vectorized) in order to retire the tasks as efficiently as possible. In any case, the ML model 260 processes the tasks 270 to generate inferences over the respective sets of data. In one or more approaches, the control module 220 controls a batching processor (e.g., a GPU separate from the processor 110) to execute the ML model 260. Thus, the control functions described herein may be executed on a separate processor from the ML model 260, which may execute on a single batching processor. Of course, in further aspects, the processor 110 may execute both the functions described in relation to the control module 220 and the ML model 260.

At 460, the control module 220 communicates results of the batch to respective requesting devices. In various approaches, the control module 220 communicates the results via wired or wireless communication networks to the original requesting device. It should be appreciated that while the batching system 170 is generally discussed as functioning within a cloud-based context, in further examples, the requestors may be local client instances and communicating may involve providing the results over a local database. In any case, the batching system 170 functions to improve batch processing of ML-based tasks by better accounting for tradeoffs between latency and energy consumption together.

As a further explanation of the batching model 280, reference will now be made to FIG. 5. FIG. 5 an abstraction 500 of the batching model 280 in relation to possible queue state transitions that can occur. Thus, the abstraction 500 represents the Markov state model employed by the batching model 280. As illustrated, task arrivals can occur at any state, where the states are represented as the separate circles in FIG. 5 with transitions as the arrows therebetween. Additionally, a top row of circles is associated with an available processor p=1, whereas the bottom row shows the processor as actively executing a batch p=0. The control module 220 can only send a batch for processing when the processer is available after which the state transitions to p=0 and the queue length decreases by a size of the batch sent for processing. Similarly, when a batch is finished processing, the state transitions to p=1, but the queue length does not change except in the case of new arrivals (which could have also occurred while the batch was being processed). As shown in FIG. 5, a state space is defined where q is the queue length, and p is the processor availability. A task arrival rate may be represented as λ, while a batch size is b_{q}.

As a general description of the batching model 280, consider the following problem formulation. The batching model 280 models the ML inference batch size decision problem as a Markov Decision Process (MDP) for a single first-in first-out (FIFO) queue and a single processor system. A system state is a combination of the queue and processor states. The queue state is determined by a length of the queue. In general, on top of the MDP, the formulation involves adding cost functions for different states (i.e., different queue states as shown in FIG. 5) and control decisions from which dynamic programming is applied to find the optimal state-dependent control decisions that minimize the total cost. For every timestep, the batching model 280 determines a cost based on the current state, energy H(q, p, bq)+latency L(q, p, bq). The batching model 280 can include a regularization parameter, η, such that it adjusts cost contribution between energy and latency: H(q, p, b_{q})+η L(q, p, b_{q}). The batching model 280 is generally configured to select a control decision (i.e., a batch size, b_{q}) to minimize average cost: Σ_{q,p} f(q,p) [H(q, p, b_{q})+η L(q, p, b_{q})], f(q,p) is the long-term equilibrium probability of being in the state p, q.

Applying dynamic programming the average cost formulation U(q, p)=min_{b_q} [H(q, p, b_{q})+η L(q, p, b_{q})+Σ_{q′,p′}U′(q′, p′)], where q′,p′ are states that can be transitioned to from the state q,p and U′(q′, p′) is the minimum cost-to-go from each of those states. Further, by using stochastic shortest path decision process modeling, the batching model 280 minimizes total cost until first hitting an empty queue with an available processor (q=0, p=1) and further assuming a stable system where the system can always hit (q=0, p=1). Accordingly, the batching model 280 is implemented, in one approach, by applying dynamic programming to recast a cost objective as a recursive function that is the sum of current costs and the expected cost for subsequent transitions, including at least a latency cost, a carbon footprint cost, and an energy cost, as shown. The batching model can then find an optimal batch size for each state in order to minimize the total expected cost until reaching an empty queue while accounting for anticipated arrivals.

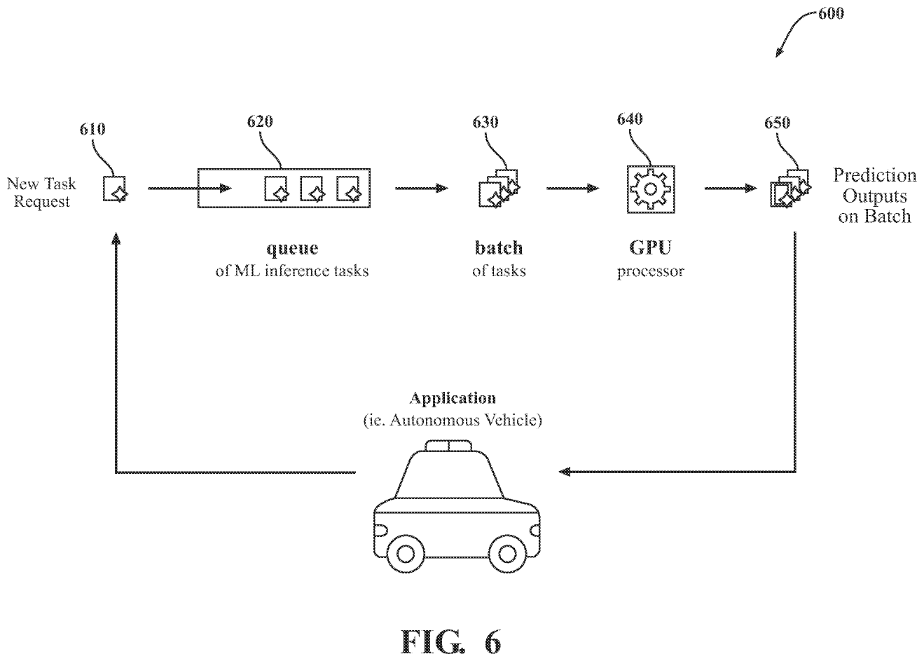

As an explicit example, consider FIG. 6, which illustrates a specific example of the batching system 170 executing in the context of an autonomous vehicle application. The top row of the diagram 600 illustrates the components, while the bottom row indicates that the requests and responses are all directed toward a latency-sensitive application such as autonomous vehicles or e-commerce recommendation engines. The application generates new inference tasks 610, which are submitted to a queue 620 that collects tasks from multiple sources. The batching model 280 evaluates a current state of the queue 620 and determines whether to delay or proceed with executing a batch of a particular size (i.e., a number of tasks present in the queue 620). The batching system 170 submits the tasks in batches 630 for processing by the graphics processing unit (GPU) 640. The processing is specifically the running of forward inference for a specific deep neural network (DNN) model, which results in a prediction result 650 for each input task. The batching system 170 then communicates the results back to the application once the batch 630 is done processing. In this way, the disclosed approach improves both energy consumption and latency for processing tasks.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Of course, in further aspects, the vehicle 100 may be a manually driven vehicle that may or may not include one or more driving assistance systems, such as active cruise control, lane-keeping assistance, crash avoidance, and so on. In any case, “manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include various types of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element, or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the batching system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement, speed, maneuvering, heading, direction, etc. of the vehicle 100. The processor(s) 110, and/or the automated driving module(s) 160 may control some or all of these vehicle systems 140 and, thus, may be partially or fully autonomous.

The processor(s) 110, and/or the automated driving module(s) 160 can be operatively connected to communicate with the various vehicle systems 140 and/or individual components thereof. For example, returning to FIG. 1, the processor(s) 110, the batching system 170, and/or the automated driving module(s) 160 can be in communication to send and/or receive information from the various vehicle systems 140 to control the movement, speed, maneuvering, heading, direction, etc. of the vehicle 100. The processor(s) 110, the batching system 170, and/or the automated driving module(s) 160 may control some or all of these vehicle systems 140.

The processor(s) 110, and/or the automated driving module(s) 160 may be operable to control the navigation and/or maneuvering of the vehicle 100 by controlling one or more of the vehicle systems 140 and/or components thereof. For instance, when operating in an autonomous mode, the processor(s) 110, and/or the automated driving module(s) 160 can control the direction and/or speed of the vehicle 100. The processor(s) 110, and/or the automated driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof responsive to receiving signals or other inputs from the processor(s) 110 and/or the automated driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine the position and velocity of the vehicle 100. The automated driving module(s) 160 can determine the location of obstacles, obstacles, or other environmental features, including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the batching system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A batching system for improving execution of machine-learning tasks, comprising:
one or more processors; and
a memory communicably coupled to the one or more processors and storing:
a control module including instructions that, when executed by the one or more processors, cause the one or more processors to:
receive, in a queue, tasks for execution, the tasks being requests to execute a machine-learning model;
evaluate a current state of the queue according to a batching model to determine when to execute a batch of the tasks by generating a cost of executing the batch at a current time; and
responsive to determining that the cost satisfies a batch threshold, control a batching processor to execute the batch using the machine-learning model.

2. The batching system of claim 1, wherein the control module includes instructions to evaluate the current state including instructions to dynamically adapt a batch size for the batch to optimize execution of the batch using the machine-learning model, and wherein the control module includes instructions to evaluate the current state using the batching model including instructions to determine a batch size for the batch to control when the batch executes according to parameters that define a tradeoff between latency and energy consumption.

3. The batching system of claim 2, wherein the control module includes instructions to evaluate the current state to determine whether to delay execution of the batch and increase a latency of execution for the batch by increasing the batch size, and wherein the batch threshold defines a limit for the cost that optimally balances the latency with energy consumption according to the parameters.

4. The batching system of claim 1, wherein the batching model is a probabilistic model that is based on a Markov Chain Model, and parameters define at least a regularization parameter, and wherein the machine-learning model is a deep neural network (DNN).

5. The batching system of claim 1, wherein the current state indicates at least an arrival rate of the tasks into the queue, and whether a batch is currently executing.

6. The batching system of claim 1, wherein the control module includes instructions to evaluate the current state using the batching model including instructions to apply dynamic programming to recast a cost objective as a recursive function that is a sum of current costs and an expected cost for subsequent transitions, including at least a latency cost, and an energy cost.

7. The batching system of claim 1, wherein the control module includes instructions to communicate results of the batch after execution to respective remote devices, and wherein receiving the tasks includes receiving the tasks from the respective remote devices that are offloading the tasks for execution.

8. The batching system of claim 1, wherein the tasks are generated by a vehicle for performing functions in relation to autonomous driving.

9. A non-transitory computer-readable medium storing instructions for improving execution of machine-learning tasks and that, when executed by one or more processors, cause the one or more processors to:
receive, in a queue, tasks for execution, the tasks being requests to execute a machine-learning model;
evaluate a current state of the queue according to a batching model to determine when to execute a batch of the tasks by generating a cost of executing the batch at a current time; and
responsive to determining that the cost satisfies a batch threshold, control a batching processor to execute the batch using the machine-learning model.

10. The non-transitory computer-readable medium of claim 9, wherein the instructions to evaluate the current state including instructions to dynamically adapt a batch size for the batch to optimize execution of the batch using the machine-learning model, and
wherein the instructions to evaluate the current state using the batching model including instructions to determine a batch size for the batch to control when the batch executes according to parameters that define a tradeoff between latency and energy consumption.

11. The non-transitory computer-readable medium of claim 10, wherein the instructions to evaluate the current state to determine whether to delay execution of the batch and increase a latency of execution for the batch by increasing the batch size, and
wherein the batch threshold defines a limit for the cost that optimally balances the latency with energy consumption according to the parameters.

12. The non-transitory computer-readable medium of claim 9, wherein the batching model is a probabilistic model that is based on a Markov Chain Model, and parameters define at least a regularization parameter, and wherein the machine-learning model is a deep neural network (DNN).

13. The non-transitory computer-readable medium of claim 9, wherein the current state indicates at least an arrival rate of the tasks into the queue, and whether a batch is currently executing.

14. A method, comprising:
receiving, in a queue, tasks for execution, the tasks being requests to execute a machine-learning model;
evaluating a current state of the queue according to a batching model to determine when to execute a batch of the tasks by generating a cost of executing the batch at a current time; and
responsive to determining that the cost satisfies a batch threshold, controlling a batching processor to execute the batch using the machine-learning model.

15. The method of claim 14, wherein evaluating the current state includes dynamically adapting a batch size for the batch to optimize execution of the batch using the machine-learning model, and wherein evaluating the current state using the batching model includes determining a batch size for the batch to control when the batch executes according to parameters that define a tradeoff between latency and energy consumption.

16. The method of claim 15, wherein evaluating the current state determines whether to delay execution of the batch and increase a latency of execution for the batch by increasing the batch size, and wherein the batch threshold defines a limit for the cost that optimally balances the latency with energy consumption according to the parameters.

17. The method of claim 14, wherein the batching model is a probabilistic model that is based on a Markov Chain Model, and parameters define at least a regularization parameter, and wherein the machine-learning model is a deep neural network (DNN).

18. The method of claim 14, wherein the current state indicates at least an arrival rate of the tasks into the queue, and whether a batch is currently executing.

19. The method of claim 14, wherein evaluating the current state using the batching model includes applying dynamic programming to recast a cost objective as a recursive function that is a sum of current costs and an expected cost for subsequent transitions, including at least a latency cost, a carbon footprint cost, and an energy cost.

20. The method of claim 14, further comprising:
communicating results of the batch after execution to respective remote devices, wherein receiving the tasks includes receiving the tasks from remote devices that are offloading the tasks for execution.
